(19) United States
(12) Patent Application Publication
(10) Pub. No.: US 2018/0333974 A1
(43) Pub. Date: Nov. 22, 2018

(54) IMAGE FORMING APPARATUS

(71) Applicant: CANON KABUSHIKI KAISHA, Tokyo (JP)

(72) Inventors: Hiroyuki Yamano, Susono-shi (JP); Tsuyoshi Nagasaki, Tokyo (JP); Satoshi Murasaki, Numazu-shi (JP)

(21) Appl. No.: 15/982,343

(22) Filed: May 17, 2018

(30) Foreign Application Priority Data
May 18, 2017 (JP) 2017-098945
Apr. 19, 2018 (JP) 2018-080814

(51) Int. Cl. B41J 29/02; B41J 2/44; H04N 1/08

(52) U.S. Cl. CPC B41J 29/02; H04N 1/0839; B41J 2/442

(57) ABSTRACT

An image forming apparatus includes a main assembly and a unit detachably mountable to the main assembly. The main assembly includes a positioning portion. The unit includes a portion-to-be-positioned engaging with the positioning portion and a grip portion configured to be gripped by a user when the unit is demounted from the main assembly. The main assembly further includes an inclined surface provided immediately in front of the positioning portion with respect to a mounting direction of the unit to the main assembly and configured to guide the portion-to-be-positioned to the positioning portion. The grip portion includes a grip surface configured to receive a force exerted in a pulling-out direction of the unit by the user when the user pulls out the unit from the main assembly. The grip surface and the inclined surface form an angle of substantially not less than 90°.

### FIELD OF THE INVENTION AND RELATED ART

The present invention relates to an image forming apparatus such as a copying machine or a printer.

Japanese Laid-Open Patent Application 2016-75752 discloses an image forming apparatus in which a fixing unit is detachably mountable to a main assembly of the image forming apparatus. A constitution in which the fixing unit can be exchanged by a user is employed. The fixing unit is positioned by engaging a positioning pin of the fixing unit with a recessed portion of a positioning groove of a main assembly frame. The fixing unit is provided with a grip portion for gripping the fixing unit.

A constitution in which when the fixing unit is demounted from the main assembly frame, a user grips the grip portion and pulls out the fixing unit is employed. However, in the case where a degree of friction between the positioning pin and the main assembly frame is large, a large force is required when the unit pulls out the fixing unit.

### SUMMARY OF THE INVENTION

The present invention has solved the above-described problem. A principal object of the present invention is to provide an image forming apparatus capable of easily pulling out a mounting and demounting unit from a main assembly of the image forming apparatus.

According to an aspect of the present invention, there is provided an image forming apparatus for forming an image on a recording material, comprising: a main assembly; and a unit detachably mountable to the main assembly; wherein the main assembly includes a positioning portion configured to position the unit, wherein the unit includes a portion-to-be-positioned engaging with the positioning portion and a grip portion configured to be gripped by a user when the unit is demounted from the main assembly, wherein the main assembly further includes an inclined surface provided immediately in front of the positioning portion with respect to a mounting direction of the unit to the main assembly and configured to guide the portion-to-be-positioned to the positioning portion, wherein the grip portion includes a grip surface configured to receive a force exerted in a pulling-out direction of the unit by the user when the user pulls out the unit from the main assembly, and wherein the grip surface and the inclined surface form an angle of substantially not less than 90°.

Further features of the present invention will become apparent from the following description of exemplary embodiments with reference to the attached drawings.

### BRIEF DESCRIPTION OF THE DRAWINGS

FIG. 1 is a sectional view showing a structure of an image forming apparatus according to the present invention.

FIG. 2 is a perspective view showing a structure of a fixing unit of First Embodiment.

FIG. 3 is a sectional view showing the structure of the fixing unit.

FIG. 4 is a perspective view showing a mounted state of the fixing unit of First Embodiment.

FIG. 5 is a side view for illustrating a force for pulling-out the fixing unit of First Embodiment.

FIG. 6 is a perspective view showing a structure of a positioning portion for positioning a mounting position of the fixing unit and a guiding portion for guiding the fixing unit to the positioning portion.

FIG. 7 is a side view showing a state before the fixing unit is pulled out from a main assembly of the image forming apparatus in First Embodiment.

FIG. 8 is a side view showing a state during pulling-out of the fixing unit from the main assembly of the image forming apparatus in First Embodiment.

FIG. 9 is a side view showing a structure of an image forming apparatus of Second Embodiment.

FIG. 10 is a perspective view of an image forming apparatus of Third Embodiment.

FIG. 11 is a sectional view of the image forming apparatus of Third Embodiment.

### DESCRIPTION OF EMBODIMENTS

Embodiments of an image forming apparatus will be specifically described with reference to the drawings.

### First Embodiment

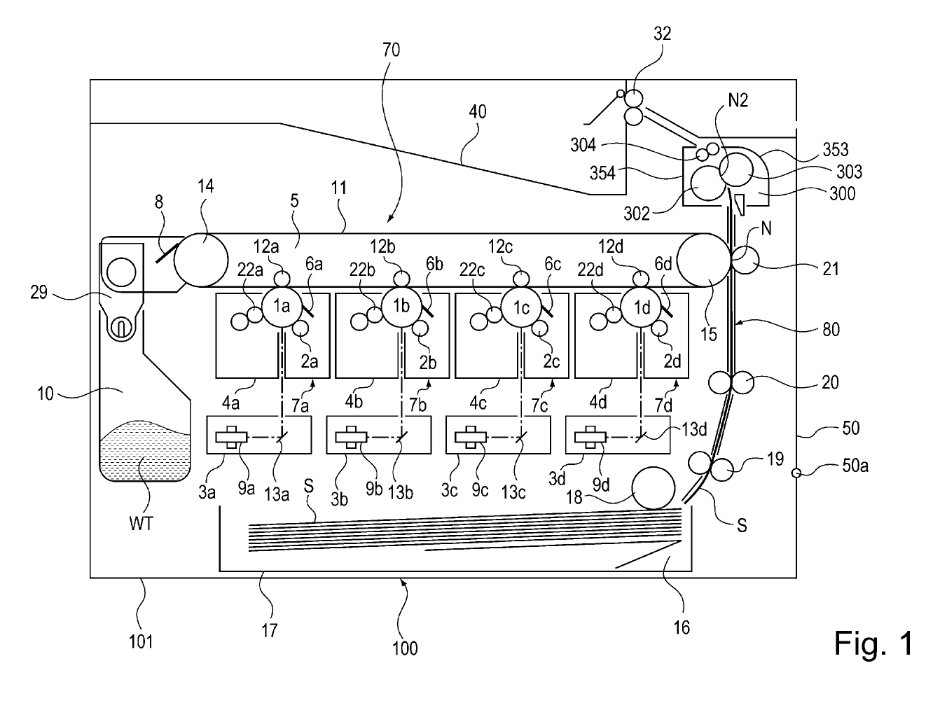

A constitution of the image forming apparatus according to First Embodiment will be described with reference to FIGS. 1 to 8.

### <Image Forming Apparatus>

First, the constitution of the image forming apparatus will be described using FIG. 1. FIG. 1 is a sectional view showing a structure of the image forming apparatus using an electrophotographic type. An image forming apparatus 100 shown in FIG. 1 is an example of a full-color laser beam printer for forming an image with use of toners of four colors of yellow, magenta, cyan and black. The image forming apparatus 100 includes an image forming portion 70 including a process cartridge 7 and includes a feeding portion 80 for feeding a recording material S to the image forming portion 70. The image forming portion 70 is constituted as an image forming means for forming the image on the recording material S.

In an apparatus main assembly 101 of the image forming apparatus 100, a fixing unit 300 which is a fixing means for fixing a toner image, carried on the recording material, on the recording material S is provided. The recording material S on which the toner image is fixed is discharged to a discharge portion 40.

The image forming portion 70 is provided at a central portion of the apparatus main assembly 101 shown in FIG. 1, and the feeding portion 80 is provided on a right(-hand) side of FIG. 1. The fixing unit 300 is disposed on an upper-right side of FIG. 1. The image forming portion 70 includes four process cartridges 7 arranged in a horizontal direction of the apparatus main assembly 101 shown in FIG. 1 and includes four scanner units 3 for exposing, to light depending on image information, surfaces of photosensitive drums 1 which are image bearing members provided in the respective process cartridges 7.

As regards these four process cartridges and four scanner units 3 and transfer rollers 12 described later, to reference numerals of the respective members, suffixes “a, b, c, d” are added corresponding to the four colors of yellow, magenta, cyan and black, respectively. These members have the same constitutions except that colors of toners (developers) are different from each other, and therefore, description will be made by omitting the suffixes “a, b, c, d” in some cases.

The photosensitive drum 1 provided in each of the process cartridges 7 is rotationally driven in the clockwise direction of FIG. 1 by an unshown driving means. At a periphery of the photosensitive drum 1, a charging roller 2 which is a charging means for electrically charging uniformly the surface of the photosensitive drum 1 is provided with respect to a rotational direction of the photosensitive drum 1. Further, a developing device 4 which is a developing means for developing, as a toner image (developer image), an electrostatic latent image formed on the surface of the photosensitive drum 1, by depositing the toner (developer) on the electrostatic latent image is provided.

Laser light is emitted on the basis of image information from between the charging roller 2 and the developing device 4 by the scanner unit 3. As a result, the uniformly charged surface of the photosensitive drum 1 is irradiated with the laser light depending on the image information, so that the electrostatic latent image is formed on the surface of the photosensitive drum 1. In the process cartridge 7, a cleaning device 6 which is a cleaning means for removing transfer residual toner remaining on the surface of the photosensitive drum 1 after primary transfer is provided.

The scanner unit 3 is disposed below the photosensitive drum 1 shown in FIG. 1. From an unshown laser diode which is a light source, laser light corresponding to an image signal is emitted. A polygon mirror 8 rotated at high speed by an unshown scanner motor is irradiated with this laser light. The laser light reflected by the polygon mirror 9 passes through an unshown lens and is reflected by a mirror 13, so that the surface of the photosensitive drum 1 is scanned with the laser light in a main scan direction. By this scanning, the electrostatic latent image corresponding to the image signal is formed on the surface of the photosensitive drum 1.

On the other hand, on a side opposite from the scanner unit 3 with respect to a position where the process cartridge 7 is provided, an intermediary transfer device 5 including an intermediary transfer belt 11 is provided. The intermediary transfer device 5 is supported by stretching rollers 14 and 15 with respect to a horizontal direction, and includes the intermediary transfer belt 11 rotationally driven in the counterclockwise direction of FIG. 1. The intermediary transfer device 5 further includes the transfer rollers 12 which are primary transfer means provided on an inner peripheral surface side of the intermediary transfer belt 11 so as to oppose the surfaces of the photosensitive drums 1. A secondary transfer roller 21 which is a secondary transfer means is contacted to the intermediary transfer belt 11 toward the stretching roller 15 with a predetermined pressure.

The intermediary transfer device 5 is provided with a cleaning device 8 which is a cleaning means for removing toner (waste (residual) toner WT) remaining on an outer peripheral surface of the intermediary transfer belt 11 after secondary transfer. The residual toner collected by the cleaning device 8 is fed by a residual toner feeding device 29 and is accommodated in a collecting container 10.

A feeding portion 80 includes a feeding portion 16 for feeding the recording material S. The feeding portion 16 feeds the recording material S, accommodated in a feeding cassette 17, to the image forming portion 70. The recording material S accommodated in the feeding cassette 17 is fed by a feeding roller 18 and is sent one by one in cooperation with an unshown separating means. The recording material S fed by the feeding roller 18 is nipped and fed by a conveying roller pair 19. The recording material S nipped and fed by the conveying roller pair 19 is abutted at a leading end portion thereof against a nip of a registration roller pair 20, so that oblique movement of the recording material S is rectified. Thereafter, the registration roller pair 20 is rotationally driven at predetermined timing, the recording material S is fed to a secondary transfer nip N formed by the outer peripheral surface of the intermediary transfer belt 11 and the secondary transfer roller 21.

### <Image Forming Operation>

An image forming operation by the image forming apparatus 100 will be described using FIG. 1. First, the respective process cartridges 7 shown in FIG. 1 are successively driven in synchronism with printing timing. At that time, the respective photosensitive drums 1 are rotationally driven in the clockwise direction of FIG. 1. Then, the charging rollers 2 impart uniform electric charges to the surfaces of the photosensitive drums 1. The scanner units 3 corresponding to the process cartridges 7 are successively driven. The uniformly charged surface of each of the photosensitive drums 1 is exposed to light depending on an image signal by the scanner unit 3, so that the electrostatic latent image is formed on the surface of the photosensitive drum 1.

In the developing device 4, a developing roller 22 which is a developer carrying member is provided. By the developing roller 22, the toner is transferred onto a low-potential portion of the electrostatic latent image formed on the surface of the photosensitive drum 1, so that the toner image is formed (by development of the electrostatic latent image) on the surface of the photosensitive drum 1. The toner images formed on the surfaces of the respective photosensitive drums 1 are successively transferred and superposed on the outer peripheral surface of the intermediary transfer belt 11 by electric fields formed between the respective photosensitive drums 1 and the associated transfer rollers 12.

On the other hand, the recording material S fed by the feeding portion 16 is conveyed by the conveying roller pair 19 and is abutted at the leading end portion thereof against the nip of the registration roller pair 20 which is at rest, so that inclination of the recording material S with respect to a feeding direction is corrected (rectified). Thereafter, at predetermined timing, the recording material S is fed to the secondary transfer nip N by the registration roller pair 20. The toner images transferred on the outer peripheral surface of the intermediary transfer belt 11 are secondary-transferred together at the secondary transfer nip onto the fed recording material S, by an electric field formed between the intermediary transfer belt 11 and the secondary transfer roller 21.

The recording material S on which the four color toner images are transferred is guided to the fixing unit 300 by nipped and fed by the outer peripheral surface of the intermediary transfer belt 11 and the secondary transfer roller 21. The toner images are heat-fixed during passing of the recording material S, on which the toner images are transferred, through a fixing nip N2 formed by a heating unit 302 and a pressing roller 303 which are provided in the fixing unit 300. The recording material S on which the toner images are fixed is fed by a feeding roller pair 304 and a discharging roller pair 32 and is electrically discharged by an unshown discharging member, and thereafter is discharged onto the discharge portion 40.

### <Mounting and Demounting Unit>

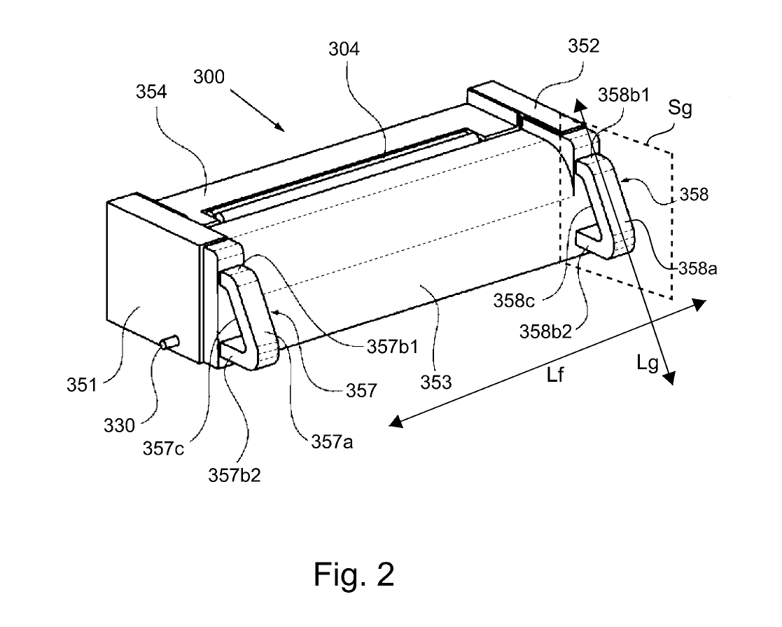

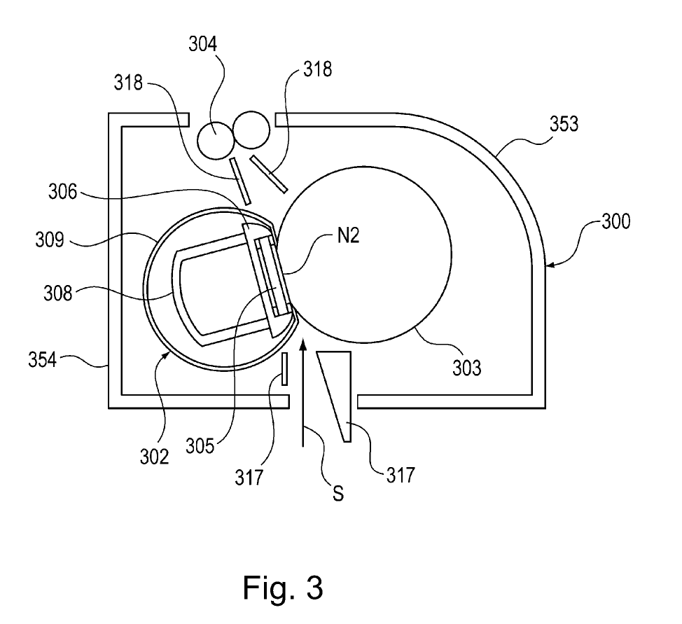

Next, a constitution of the fixing unit 300 which is an example of a mounting and demounting unit will be described using FIGS. 2 and 3. FIG. 2 is a perspective view showing a structure of the fixing unit 300. FIG. 3 is a sectional view showing the structure of the fixing unit 300. As shown in FIG. 3, the fixing unit 300 includes the heating unit 302 and further includes the pressing roller 303 press-contacted to the heating unit 302. Heat and pressure are applied to the toner images during the nip-feeding of the recording material S, carrying the toner images, by the heating unit 302 and the pressing roller 303, so that the toner images (developer images) carried on the recording material S are fixed on the recording material S.

An entrance guide 317 is provided upstream, with respect to a feeding direction of the recording material S, of the fixing nip N2 formed by the heating unit 302 and the pressing roller 303. Further, an exit guide 318 is provided downstream of the fixing nip N2 with respect to the feeding direction of the recording material S. On a side further downstream of the exit guide 318, the feeding roller pair 304 is provided.

The recording material S is fed from below toward above in the fixing unit 300 in FIG. 3. As shown in FIG. 1, in a state in which the fixing unit 300 is mounted in an image forming position of the apparatus main assembly 101, the heating unit 302 and the pressing roller 303 are disposed at positions along a front-rear direction (left-right direction of FIG. 1) of the apparatus main assembly 101. The pressing roller 303 is covered with a rear cover 353, and the heating unit 302 is covered with a front cover 354. The heating unit 302 is constituted by including a heater 305 formed with a planar heat generating member, a supporting member 306 for supporting the heater 305, a pressing stay 308, and a fixing film 309 rotated in the counterclockwise direction of FIG. 3 while incorporating these members therein.

A longitudinal direction Lf of the fixing unit 300 is an axial direction of the heating unit 302 and the pressing roller 303.

Next, an outer casing structure of the fixing unit 300 will be described using FIG. 2. As shown in FIG. 2, the outer casing structure of the fixing unit 300 includes the front cover 354 and the rear cover 353 which cover front and rear portions of the fixing unit 300, and includes end portion covers 351 and 352 which cover both end portions of the fixing unit 300 with respect to the longitudinal direction of the fixing unit 300. On the surfaces of the end portion covers 351 and 352, positioning pins 330 projecting outward with respect to the longitudinal direction of the fixing unit 300 are provided.

Incidentally, in FIG. 2, only the positioning pin 330 projecting outward from the surface of the end portion cover 351 is shown, but also from the surface of the end portion cover 352, an unshown positioning pin 330 projects outward. On a rear (surface) side of the rear cover 353, handles 357 and 358 which are grip portions through which a user grips the fixing unit 300 and which are constituted in a ring shape. As shown in FIG. 2, the handles 357 and 358 are provided so that a longitudinal direction Lg of each of the handles 357 and 358 crosses the longitudinal direction Lf of the fixing unit 300. Further, the handles 357 and 358 are provided so that a plane Sg formed by a ring of each of the handles 357 and 358 crosses the longitudinal direction Lf of the fixing unit 300.

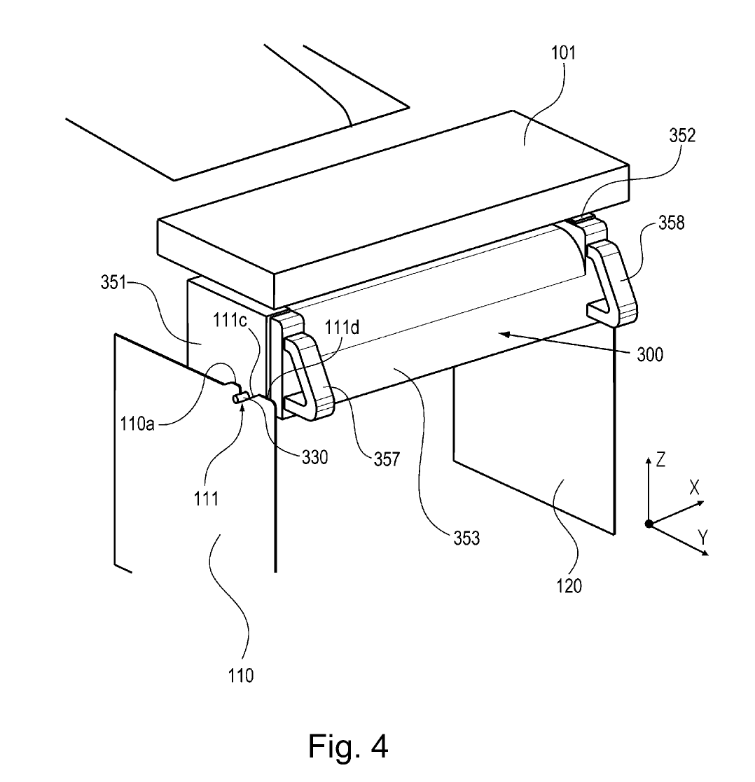

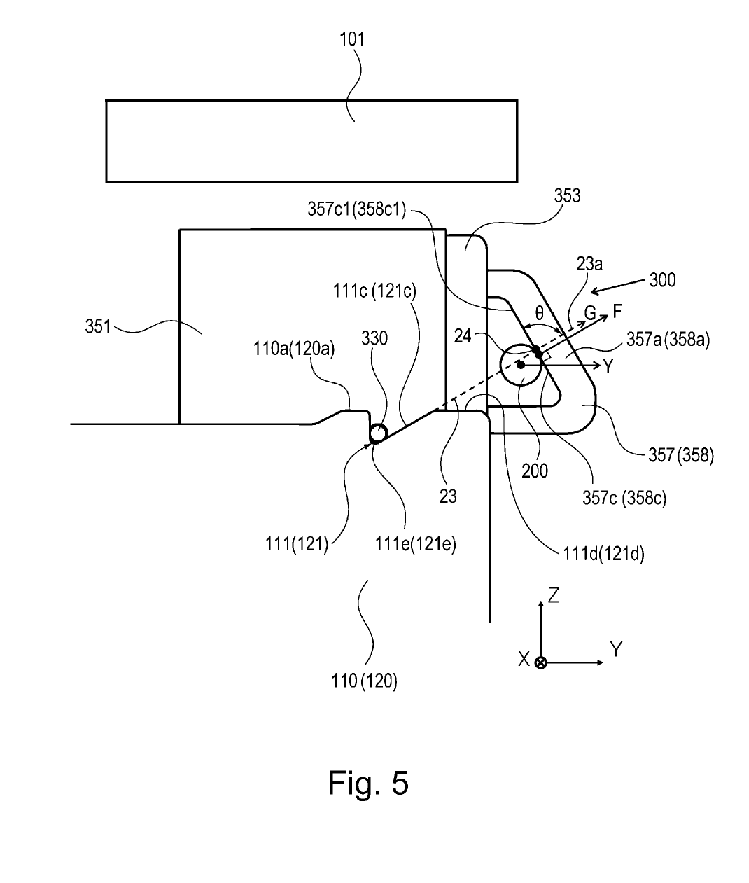

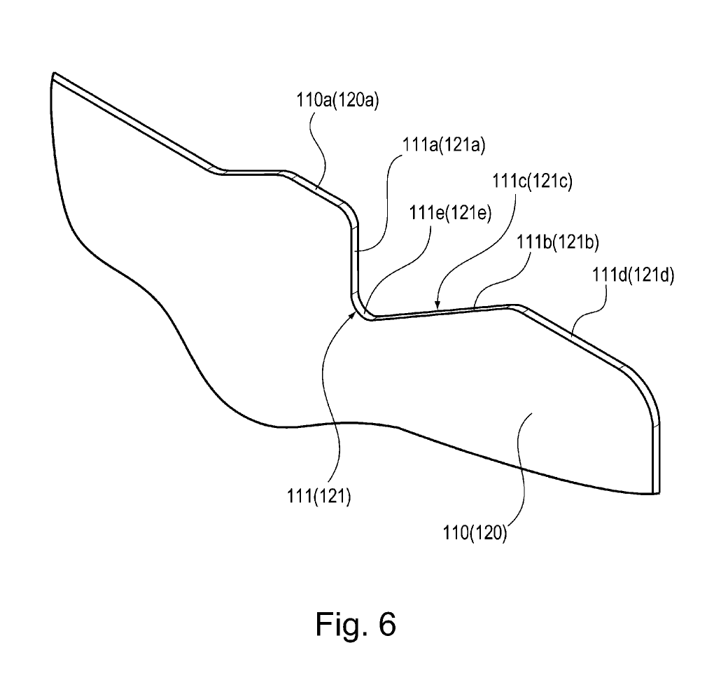

FIG. 4 is a perspective view showing a mounted state of the fixing unit 300 of this embodiment. FIG. 5 is a side view for illustrating a force for pulling out the fixing unit 300 of this embodiment. FIG. 6 is a perspective view showing a structure of a positioning portion for positioning a mounting position of the fixing unit 300 and a guiding portion for guiding the fixing unit 300 to the positioning portion.

As shown in FIGS. 4 and 5, at upper edges 110a and 120a of main assembly frames 110 and 120 of the apparatus main assembly 101, V-shaped groove portions 111 and 121 are provided. The groove portions 111 and 121 are provided with groove bottom portions 111e and 121e which are positioning portions for determining a position of the fixing unit 300 (mounting and demounting unit) relative to the apparatus main assembly 101.

The apparatus main assembly 101 includes inclined surfaces 111c and 121c for guiding the positioning pins 330 (portions-to-be-positioned), provided so as to project from the both longitudinal end portions of the fixing unit 300 (mounting and demounting unit), to the groove bottom portions 111e and 121e (positioning portions). The inclined surfaces 111c and 121c are provided continuously from the groove bottom portions 111e and 121e, respectively. Each of the inclined surfaces 111c and 121c of this embodiment has a rectilinear shape.

The fixing unit 300 (mounting and demounting unit) includes the positioning pins 330 which are the portions-to-be-positioned for determining the position of the fixing unit 300 relative to the apparatus main assembly 101. The positioning pins 330 are provided so as to project outward from the end portion covers 351 and 352, respectively, of the fixing unit 300. The positioning pins 330 are engaged, as shown in FIGS. 4 and 5, in the groove bottom portions 111e and 121e (positioning portions), so that the fixing unit 300 is positioned in the image forming position. Further, the positioning pins 330 are slidably contacted to and guided by the inclined surfaces 111c and 121c (guiding portions).

The fixing unit 300 is capable of being pulled out of the apparatus main assembly 101. A direction in which the fixing unit 300 moves in a horizontal plane of FIG. 5 when the fixing unit 300 is pulled out from the apparatus main assembly 101 is an arrow Y direction. A direction perpendicular to the arrow Y direction of FIG. 5 is a first direction (substantially equal to the direction Lf). A second direction perpendicular to the arrow Y direction and the first direction X of FIG. 5 is Z direction.

The groove portions 111 and 121 include sides (accurately, edges of the frames) 111a and 121a which are provided in side with respect to the apparatus main assembly 101 and include sides 111b and 121b which are provided outside with respect to the apparatus main assembly 101. The sides 111a and 121a extend in a direction (up-down direction) parallel to the second direction Z. The sides 111b and the 121b include the inclined surfaces 111c and 121c, respectively, inclined upward toward the outside with respect to the horizontal plane.

As shown in FIG. 6, in the groove bottom portions 111e and 121e (positioning portions) formed between the side 111a or 121a and the side 111b or 121b, the positioning pins 330 projecting outward in the longitudinal direction of the fixing unit 300 engage. At this time, as shown in FIG. 4, the end portion covers 351 and 352 provided at the longitudinal end portions of the fixing unit 300 are engaged between the main assembly frames 110 and 120. As a result, outer surfaces of the end portion covers 351 and 352 of the fixing unit 300 are regulated by inner surfaces of the main assembly frames 110 and 120. As a result, positions of the fixing unit 300 with respect to the first direction X, the second direction Z and the direction Y are determined.

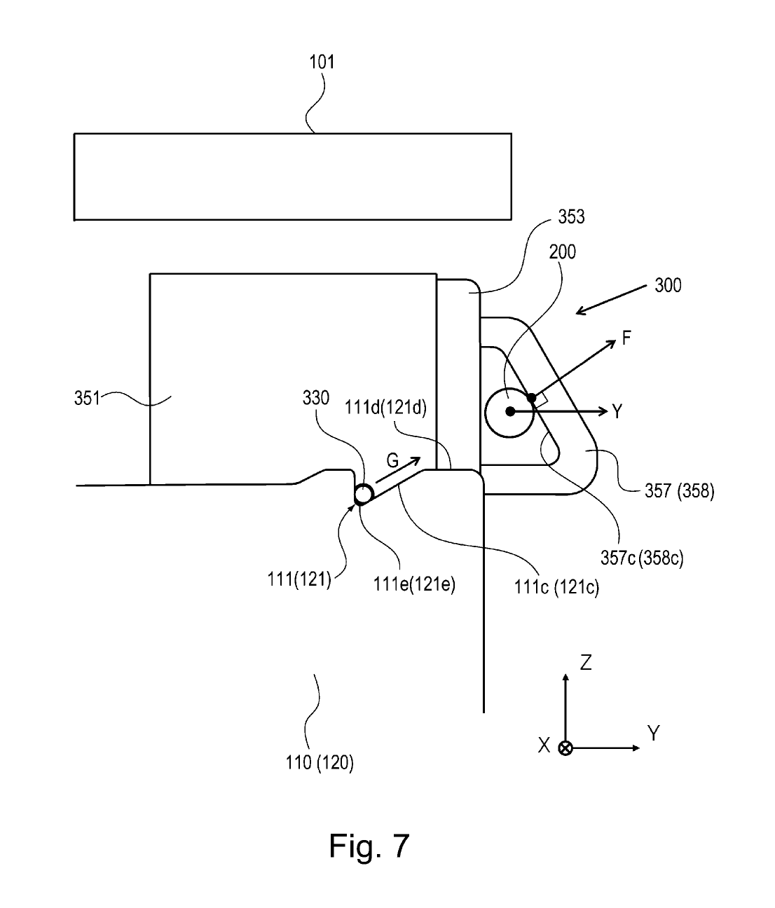

As shown in FIG. 7, an attitude of the fixing unit 300 when the fixing unit 300 is pulled out of the apparatus main assembly 101 is such that the longitudinal direction Lf of the fixing unit 300 coincides with the first direction X. In that state, the user grips the handles 357 and 358 and pulls out the fixing unit 300 in a direction of a force F of FIG. 5. Thus, the positioning pins 330 are slid along the inclined surfaces 111c and 121c, so that first, the fixing unit 300 is moved in the +Y direction and the +Z direction relative to the apparatus main assembly 101.

Thereafter, the positioning pins 330 are slid along top surfaces 111d and 121d continuous to the inclined surfaces 111c and 121c, respectively, so that the fixing unit 300 is further moved in the +Y direction. At this time, the outer surfaces of the end portion covers 351 and 352 of the fixing unit 300 are regulated by the inner surfaces of the main assembly frames 110 and 120, respectively, so that the fixing unit 300 is guided in the Y direction and the Z direction while preventing (regulating) movement thereof in the first direction X.

### <Grip Portion>

A constitution of the handles 358 and 358 which are grip portions will be described using FIGS. 2 and 5. As shown in FIG. 2, each of the handles 357 and 358 is fixed on the rear surface of the rear cover 353. The handles 357 and 358 include a pair of leg portions 357b1 and 357b2 and a pair of leg portions 358b1 and 358b2, respectively, which are provided at upper and lower end portions of the fixing unit 300 and which extend toward the front side, and include grip portions 357a and 358a connecting the upper and lower leg portions 357b1 and 357b2 and the upper and lower leg portions 358b1 and 358b2, respectively. As a result, the handles 357 and 358 are constituted in the ring shape on the rear surface of the rear cover 353.

As shown in FIG. 5, the grip portions 357a and 358a are provided with groove portions 357c and 358c on which the user grips the grip portions with fingers 200 when the user pulls out the fixing unit 300 from the apparatus main assembly 101 and by which a force F for pulling out the fixing unit 300 is received are provided. The grip surfaces 357c and 358c of this embodiment are formed in the rectilinear shape.

Next, angles at which the grip surfaces 357c and 358c shown in FIG. 5 cross a phantom surface 23 extended from the inclined surfaces 111c and 121c in a pulling-out direction (rightward direction of FIG. 5) of the fixing unit 300 (mounting and demounting unit) will be considered. Of angles, an angle θ formed between a phantom surface portion 23a, positioned downstream of a line of intersection 24 between the phantom surface 23 and the grip surfaces 357c and 358c with respect to the pulling-out direction (rightward direction of FIG. 5) of the fixing unit 300, and the grip surfaces 357c and 358c on a side (upper side of FIG. 5) vertically above the line of intersection 24 will be considered. The angle θ is set at substantially right angle. Further, the grip surfaces 357c and 358c are provided so as to cross extended lines of the inclined surfaces 111c and 121c.

As a result, the direction of the force F for pulling out the fixing unit 300 from the apparatus main assembly 101 by the user and a direction G of (extended lines of) the inclined surfaces 111c and 121c are set so as to be substantially parallel to each other.

### <Pulling-Out Operation of Fixing Unit>

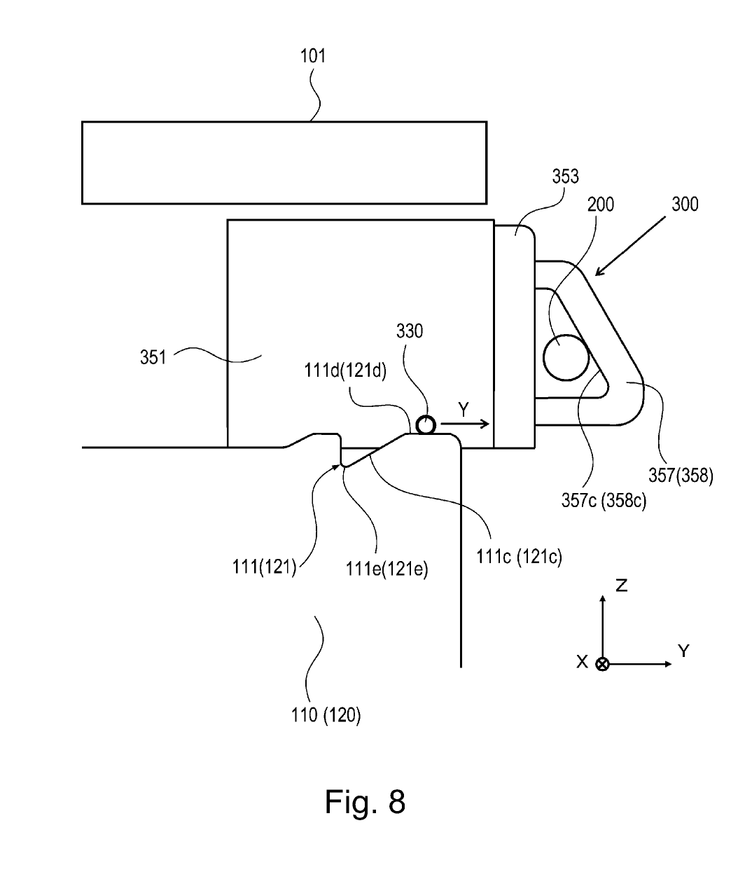

Next, a pulling-out operation of the fixing unit 300 from the apparatus main assembly 101 will be described using FIGS. 7 and 8. FIG. 7 is a side view showing a state before the fixing unit 300 is pulled out of the apparatus main assembly 101. FIG. 8 is a side view showing a state during the pulling-out of the fixing unit 300 from the apparatus main assembly 101.

FIG. 7 shows a state in which the fixing unit 300 is mounted at the image forming position of the apparatus main assembly 101. In this state, the fixing unit 300 is positioned in a state in which the positioning pins 330 projecting from the end portion covers 351 and 352 of the fixing unit 300 are engaged in the groove bottom portions 111e and 121e of the groove portions 111 and 121 of the main assembly frames 110 and 120.

When the user pulls out the fixing unit 300, mounted at the image forming position, from the apparatus main assembly 101, first, the user opens an openable door 50 provided rotatably about a hinge portion 50a as a part of the apparatus main assembly 101. Then, the user will pull out the fixing unit 300 in a direction along the arrow Y direction in a state in which the user grips the grip surfaces 357a and 358c of the handles 357 and 358 of the fixing unit 300 with the fingers 200. At this time, to the grip surfaces 357c and 358c, only the force F exerted from the fingers 200 in the direction perpendicular to the grip surfaces 357c and 358c is transmitted.

The grip surfaces 357c and 358c are substantially perpendicular to the inclined surfaces 111c and 121c of the groove portions 111 and 121 which are provided on the main assembly frames 110 and 120. For that reason, a force actually acting on the fixing unit 300 as a force intended to move the fingers 200 in the arrow Y direction acts in the direction of the force F substantially perpendicular to the grip surfaces 357c and 358c (substantially parallel to the inclined surfaces 111c and 121c).

As a result, the positioning pins 330 provided on the end portion covers 351 and 352 of the fixing unit 300 so as to project from the end portion covers 351 and 352 can be naturally moved along the inclined surfaces 111c and 121c in the +Y direction and the +Z direction. As a result, a frictional force acting between the positioning pins 330 and the inclined surfaces 111c and 121c can be decreased. As a result, the positioning pins 330 can be smoothly moved along the inclined surfaces 111c and 121c with a small force.

FIG. 8 shows a state in which the positioning pins 330 continuously move on the inclined surfaces 111c and 121c and reach the top surfaces 111d and 121d during the pulling-out of the fixing unit 300 from the apparatus main assembly 101. The handles 357 and 358 are formed in the ring shape, and therefore a state in which the user grips the handles 357 and 358 with the fingers 200 is formed. As a result, it is possible to prevent a drop of the fixing unit 300 when the user takes out the fixing unit 300 from the apparatus main assembly 101.

In this embodiment, when the user pulls out the fixing unit 300 from the apparatus main assembly 101, the force F for pulling out the fixing unit 300 is exerted in a direction substantially parallel to a direction G along the inclined surfaces 111c and 121c provided on the groove portions 111 and 121 of the main assembly frames 110 and 120. As a result, the positioning pins 330 of the fixing unit 300 can smoothly move in the direction G along the inclined surfaces 111c and 121c while sliding on the inclined surfaces 111c and 121c, provided on the groove portions 111 and 121 of the main assembly frames 110 and 120, with the small frictional force.

As a result, the user can easily pull out the fixing unit 300 from the apparatus main assembly 101 with the small force. As a result, usability (ease of use) can be improved. Mounting and demounting of the fixing unit 300 are carried out in a state in which the user grips the ring-shaped handles 357 and 358 with the fingers 200, and therefore, the drop of the fixing unit 300 can be prevented. Incidentally, a mounting operation of the fixing unit 300 can be carried out such that the user opens the openable door 50 shown in FIG. 1 and grips the handles 357 and 358, and then mounts the fixing unit 300 in the order of FIG. 8 and FIG. 7.

### Second Embodiment

Next, a constitution of Second Embodiment of an image forming apparatus according to the present invention will be described. Incidentally, constituent elements similar to those of First Embodiment described above are represented by the same reference numerals or symbols or by adding thereto the same member (component) names even when the reference numerals or symbols are different from those of First Embodiment, and will be omitted from description.

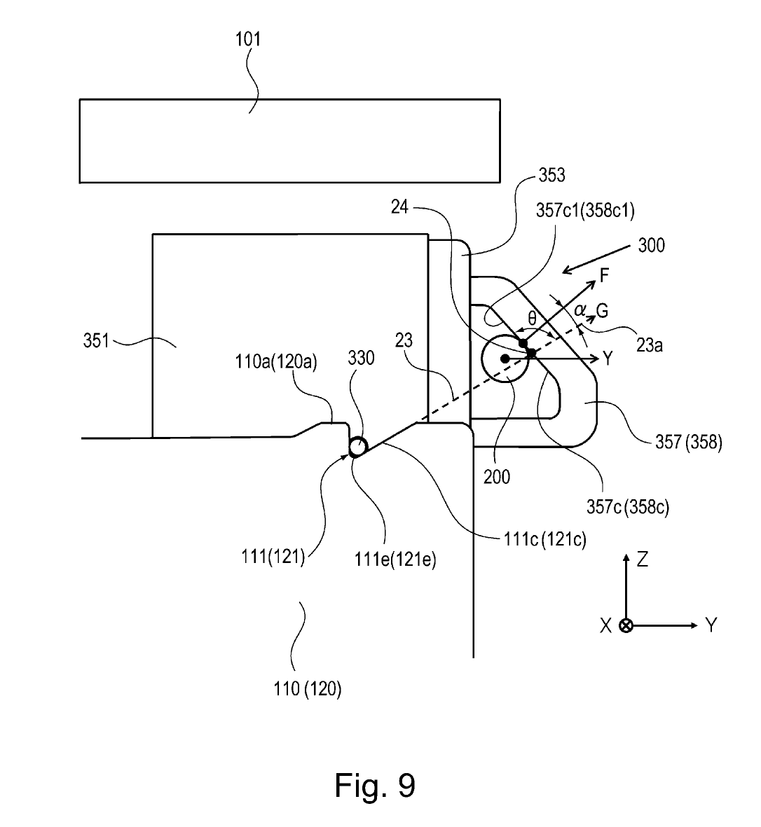

In this embodiment, as shown in FIG. 9, an angle θ formed between a phantom surface portion 23a, positioned downstream of a line of intersection 24 between the phantom surface 23 and the grip surfaces 357c and 358c with respect to the pulling-out direction (rightward direction of FIG. 9) of the fixing unit 300, and the grip surfaces 357c and 358c on a side (upper side of FIG. 9) vertically above the line of intersection 24 will be considered. FIG. 9 shows an example in which the angle θ is set at an obtuse angle larger than the right angle.

When First Embodiment and this embodiment are considered, it would be understood that the angle θ may preferably be set at the right angle or the angle larger than the right angle.

In this state, an angle α formed between the direction G along the inclined surfaces 111c and 121c and the force F actually acting on the fixing unit by the force intended by the user to move the finger 200, with which the user grips the grip portions 357c and 358c, in the angle Y direction.

For that reason, the direction of the force F for pulling out the fixing unit 300 from the apparatus main assembly 101 is oriented upward compared with the direction G in which the fixing unit 300 is pulled out so that the positioning pins 330 (portions-to-be-positioned) are guided by the inclined surfaces 111c and 121c (guiding portions).

As a result, the positioning pins 330 of the fixing unit 300 can smoothly move in the direction G along the inclined surfaces 111c and 121c while sliding on the inclined surfaces 111c and 121c, provided on the groove portions 111 and 121 of the main assembly frames 110 and 120, with a further small frictional force.

Other constitutions are constituted similarly as in First Embodiment, so that an effect similar to that of First Embodiment can be obtained.

### Third Embodiment

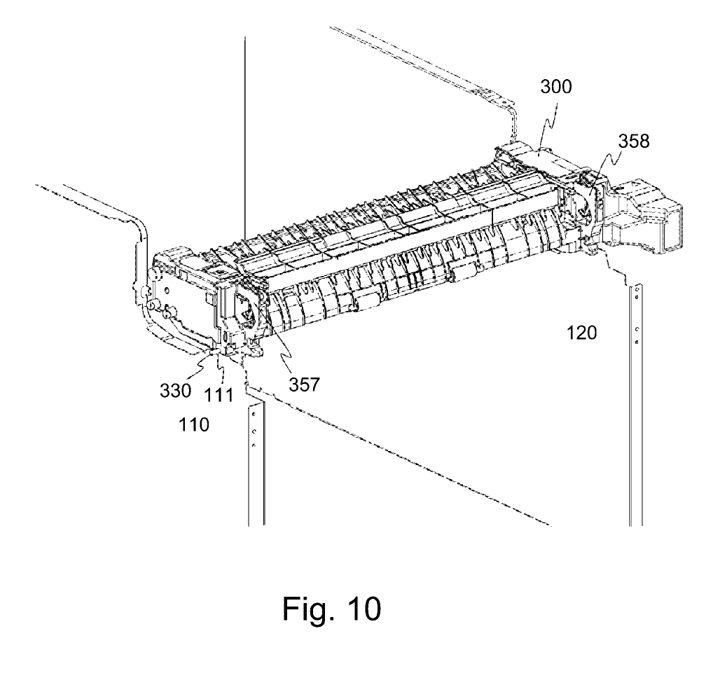

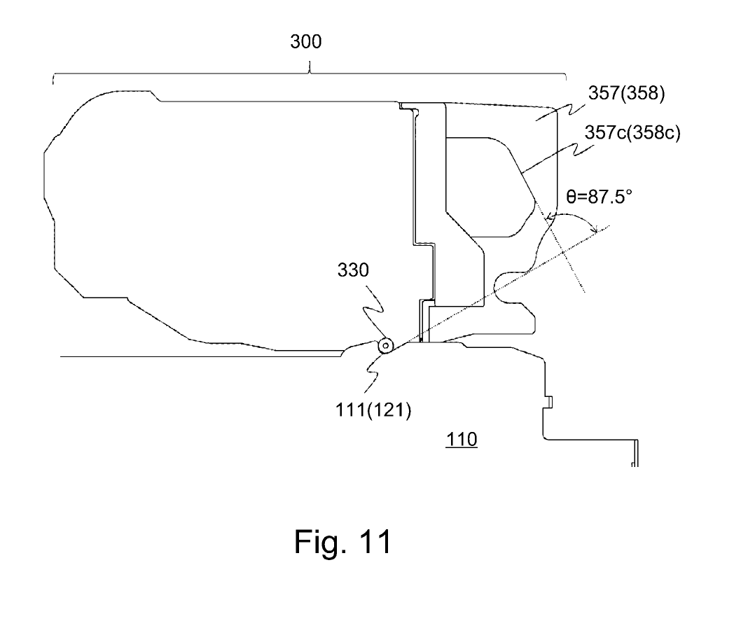

FIGS. 10 and 11 show Third Embodiment. A constitution of an apparatus main assembly 101 of this embodiment is the same as that of First Embodiment. Positions and an angle θ of grip surfaces 357c and 358c of a fixing unit 300 are different from those of First Embodiment. The grip surfaces 357c and 358c of the fixing unit 300 in this embodiment are provided at positions deviated from extended lines of inclined surfaces 111c and 121c. Further, the angle θ is set at 87.5°, so that the angle θ is somewhat smaller than 90°. Thus, not only in the constitution in which the grip surfaces 357c and 358c are positioned so as to cross the extended lines of the inclined surfaces 111c and 121c, but also in the constitution in which the grip surfaces 357c and 358c are in the positions deviated from the extended lines of the inclined surfaces 111c and 121c, the fixing unit 300 can be smoothly pulled out by constituting the grip surfaces so that the angle θ satisfies: 85°≤θ≤120°.

Incidentally, in the above-described embodiments, the case where the present invention is applied to the full-color laser beam printer as the image forming apparatus 100 including the mounting and demounting unit detachably mountable to the image forming apparatus main assembly was described, but the present invention is not limited to the color image forming apparatus 100. As another embodiment, the present invention is also applicable to a monochromatic image forming apparatus 100. Further, in the above-described embodiments, the shape of the groove portions 111 and 121 is the V-shape, but various other shapes are also applicable when the shapes provide inclined surfaces 111c and 121c which are inclined upward with respect to the horizontal plane.

The positioning pins 330 projecting outward from the end portion covers 351 and 352 of the fixing unit 300 were described as an example of the portions-to-be-positioned, but the shape of the portions-to-be-positioned is not limited to the pin shape. As another example, portions-to-be-positioned which includes inclined surfaces contactable and slidable with the inclined surfaces 111c and 121c and which have various shapes may also be used. Further, the shape of the handles 357 and 358 of the fixing unit 300 was the ring shape, but is not limited to the ring shape. As another example, L-shaped handles which are the handles 357 and 358, shown in FIG. 2, from which the lower leg portions 357b2 and 358b2 are removed may also be used.

Incidentally, in the above-described embodiments, an example of the case where the fixing unit 300 is applied to the image forming apparatus 100, to which the fixing unit 300 is detachably mountable, as the image forming apparatus 100 including the mounting and demounting unit detachably mountable to the image forming apparatus main assembly was described. However, the mounting and demounting unit is not limited to the fixing unit 300. As another example, the present invention is also applicable to a mounting and demounting unit of the process cartridge 7 and other various mounting and demounting units.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2017-098945 filed on May 18, 2017 and 2018-080814 filed on Apr. 19, 2018, which are hereby incorporated by reference herein in their entirety.

What is claimed is:

1. An image forming apparatus for forming an image on a recording material, comprising:
a main assembly; and
a unit detachably mountable to said main assembly;
wherein said main assembly includes a positioning portion configured to position said unit,
wherein said unit includes a portion-to-be-positioned engaging with said positioning portion and a grip portion configured to be gripped by a user when said unit is demounted from said main assembly,
wherein said main assembly further includes an inclined surface provided immediately in front of said positioning portion with respect to a mounting direction of said unit to said main assembly and configured to guide said portion-to-be-positioned to said positioning portion,
wherein said grip portion includes a grip surface configured to receive a force exerted in a pulling-out direction of said unit by the user when the user pulls out said unit from said main assembly, and
wherein said grip surface and said inclined surface form an angle of substantially not less than 90°.

2. An image forming apparatus according to claim 1, wherein the angle formed between said grip surface and said inclined surface is 85° or more and 120° or less.

3. An image forming apparatus according to claim 1, wherein said grip portion is provided so that a longitudinal direction of said grip surface crosses a longitudinal direction of said unit.

4. An image forming apparatus according to claim 3, wherein a shape of said grip portion is a ring shape, and said grip portion is formed so that a surface formed by a ring of said grip portion crosses a longitudinal direction of said unit.

5. An image forming apparatus according to claim 1, wherein said grip portion is provided at each of end portions of said unit with respect to a longitudinal direction of said unit.

6. An image forming apparatus according to claim 1, further comprising a horizontal surface provided immediately in front of said inclined surface with respect to the mounting direction of said unit and configured to guide and positioning portion to said inclined surface.

7. An image forming apparatus according to claim 1, wherein said grip surface is provided so as to cross an extended line of said inclined surface.

8. An image forming apparatus according to claim 1, wherein said grip surface is provided at a position deviated from an extended line of said inclined surface.

9. An image forming apparatus according to claim 1, wherein said unit is a fixing unit configured to fix the image on the recording material.
